(19) United States
(12) Patent Application Publication
(10) Pub. No.: US 2023/0001819 A1
(43) Pub. Date: Jan. 5, 2023

(54) INFORMATION PROCESSING DEVICE, INFORMATION PROCESSING METHOD, AND STORAGE MEDIUM

(71) Applicant: TOYOTA JIDOSHA KABUSHIKI KAISHA, Toyota-shi (JP)

(72) Inventors: Yu NAGATA, Tokyo (JP); Toshihiro NAKAMURA, Suntou-gun (JP)

(73) Assignee: TOYOTA JIDOSHA KABUSHIKI KAISHA, Toyota-shi (JP)

(21) Appl. No.: 17/824,050

(22) Filed: May 25, 2022

(30) Foreign Application Priority Data
Jul. 5, 2021 (JP) 2021-111807

(51) Int. Cl. B60L 53/66; H02J 7/00; B60L 53/62

(52) U.S. Cl. CPC B60L 53/66; H02J 7/0048; H02J 7/0071; B60L 53/62

(57) ABSTRACT

An information processing device includes a control unit configured to perform: acquiring a charging time required for charging a battery with which a predetermined device is operated with a first state of charge for each of a plurality of charging methods; and notifying the predetermined device of the charging times acquired for the plurality of charging methods.

### CROSS-REFERENCE TO RELATED APPLICATION

This application claims priority to Japanese Patent Application No. 2021-111807 filed on Jul. 5, 2021, incorporated herein by reference in its entirety.

### BACKGROUND

### 1. Technical Field

The present disclosure relates to an information processing device, an information processing method, and a storage medium.

### 2. Description of Related Art

Currently, various devices that are operated with a battery, including mobile objects such as electric vehicles and portable information devices, are used. For example, Japanese Unexamined Patent Application Publication No. 2011-215059 (JP 2011-215059 A) describes that a control device retrieves high-rate charging facilities with relatively high charging rates and low-rate charging facilities with relatively low charging rates in a travel range in which a vehicle can travel with a residual capacity of a battery, estimates the residual capacity of the battery if the vehicle were to travel to a high-rate charging facility, and broadens a non-display range of the low-rate charging facilities near the high-rate charging facilities as the estimated residual capacity decreases.

### SUMMARY

An aspect of the present disclosure is for allowing a user of a device with a battery mounted therein to ascertain a difference in charging time using different charging methods and to flexibly select a charging method.

An aspect of the present disclosure is embodied as an information processing device. The information processing device includes a control unit configured to perform: acquiring a charging time required for charging a battery with which a predetermined device is operated with a first charging capacity for each of a plurality of charging methods; and notifying the predetermined device of the charging times acquired for the plurality of charging methods.

Another aspect of the present disclosure is embodied as an information processing method that is performed by a computer. The information processing method includes: acquiring a charging time required for charging a battery with which a predetermined device is operated with a first charging capacity for each of a plurality of charging methods; and notifying the predetermined device of the charging times acquired for the plurality of charging methods.

Another aspect of the present disclosure is embodied as a storage medium. The storage medium stores a program for causing a computer to perform: acquiring a charging time required for charging a battery with which a predetermined device is operated with a first charging capacity for each of a plurality of charging methods; and notifying the predetermined device of the charging times acquired for the plurality of charging methods.

With the information processing device, it is possible to allow a user of a device with a battery mounted therein to ascertain a difference in charging time using different charging methods and to flexibly select a charging method.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration of an information system according to a first embodiment;

FIG. 2 is a diagram illustrating charging characteristics of a battery that operates a portable electronic device;

FIG. 3 is a diagram illustrating power consumption characteristics of a portable electronic device;

FIG. 4 is a diagram illustrating an example of schedule management information of a user;

FIG. 5 is a diagram illustrating an example of a charging spot management table;

FIG. 6 is a flowchart illustrating a process of calculating a charging time of a battery which is performed by a computer;

FIG. 7 is a diagram illustrating a configuration of an information system according to a second embodiment;

FIG. 8 is a diagram illustrating an example of schedule management information of a user according to the second embodiment; and

FIG. 9 is a diagram illustrating an example of operation schedule information of a mobile object.

### DETAILED DESCRIPTION OF EMBODIMENTS

Hereinafter, an information processing device, an information processing method, and an information system according to an embodiment will be described with reference to the accompanying drawings. The information processing device includes a control unit configured to perform acquiring a charging time required for charging a battery with which a predetermined device is operated with a first state of charge for each of a plurality of charging methods and notifying the predetermined device of the charging times acquired for the plurality of charging methods.

Here, the predetermined device is not particularly limited as long as it is a device, an instrument, or the like which is operated with a battery. The battery is called a rechargeable secondary battery or a storage battery. The first charging capacity required for the battery is a charging capacity for securing a residual capacity of the battery required for the predetermined device to provide a function to a user when a first time has elapsed. For example, it is preferable that the battery be charged with an amount of electric power for enabling provision of a function such that a plan for use of the predetermined device, an action schedule of the user, or the like is not affected by charging with the first charging capacity in the range of the first time. The first time is, for example, an elapsed time from a current time point to the next date and time at which charging is assumed to be possible (charging opportunity).

The plurality of charging methods is charging methods using various charging facilities or charging devices which can be adapted to the predetermined device. As the charging methods, regular charging or fast charging can be performed according to a difference in charging rate. A plurality of charging specifications or standards is prescribed for regular charging and fast charging according to a difference in charging voltage or charging current.

### First embodiment

System Configuration

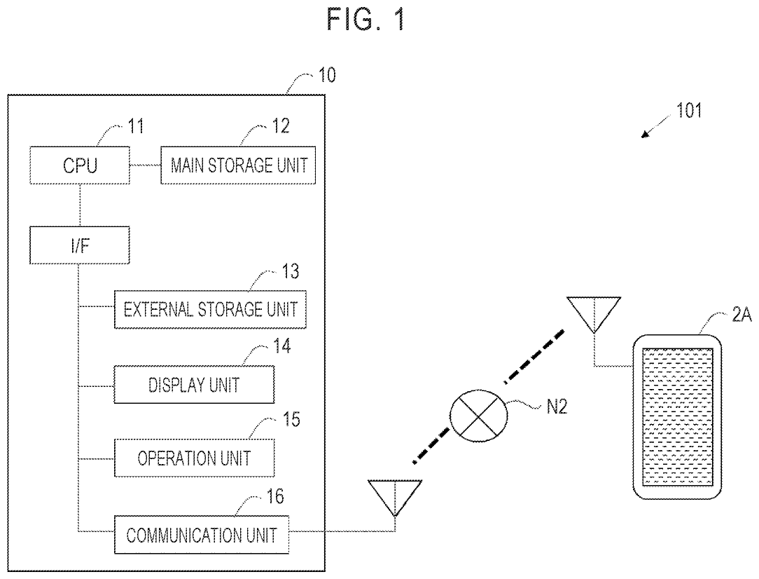

FIG. 1 is a diagram illustrating a configuration of an information system 101 according to a first embodiment. The information system 101 includes a computer 10 and a portable electronic device 2A. The computer 10 is also referred to as a server. The portable electronic device 2A is, for example, a terminal that can perform radio communication. The computer 10 includes a central processing unit (CPU) 11, a main storage unit 12, and an external unit that is connected thereto via an interface (I/F) and performs information processing in accordance with a computer program. The CPU 11 is also referred to as a processor. The CPU 11 is not limited to a single processor and may include multiple processors. The CPU 11 may include a graphics processing unit (GPU) and a digital signal processor (DSP). The CPU 11 may cooperate with a hardware circuit such as a field programmable gate array (FPGA). Examples of the external unit include an external storage unit 13, a display unit 14, an operation unit 15, and a communication unit 16.

The CPU 11 provides a function of the control computer 10 by executing computer programs which are executably loaded to the main storage unit 12. The main storage unit 12 stores the computer programs executed by the CPU 11, data processed by the CPU 11, and the like. The main storage unit 12 includes a dynamic random access memory (DRAM), a static random access memory (SRAM), or a read only memory (ROM). The external storage unit 13 is used, for example, as a storage area for assisting the main storage unit 12. The external storage unit 13 stores computer programs executed by the CPU 11, data processed by the CPU 11, and the like. The external storage unit 13 is a hard disk drive (HDD), a solid disk drive (SSD), or the like. A drive device for a detachable storage medium may be provided in the computer 10. Examples of the detachable storage medium include a Blu-ray disc, a digital versatile disk (DVD), a compact disc (CD), and a flash memory card.

The computer 10 includes a display unit 14, an operation unit 15, and a communication unit 16. The display unit 14 is, for example, a liquid crystal display or an electroluminescence panel. The operation unit 15 is, for example, a keyboard or a pointing device. In this embodiment, a mouse is exemplified as the point device. The communication unit 16 transmits and receives data to and from another device over a network. For example, the communication unit 16 communicates with the portable electronic device 2A via a network N2. The network N2 includes a wired network and a wireless network. The wired network is also referred to as, for example, a core network or a backbone and is a broadband network such as an optical fiber network. The wireless network includes, for example, a mobile phone network such as Long Term Evolution (LTE), a 5th-generation mobile communication system (5G), or a 6th-generation mobile communication system (6G).

The configuration of the portable electronic device 2A is the same as that of the computer 10. Here, the portable electronic device 2A includes a touch panel in which a touch sensor is superimposed on a display as an operation unit. The portable electronic device 2A has a built-in battery and operates with energy (electric power, electric charge) stored in the battery. Various charging devices are used as a charging mechanism for charging the battery. In this embodiment, a charging mechanism for regular charging and a charging mechanism for fast charging are exemplified. The charging mechanisms are not limited to the two types for regular charging and fast charging. A user of the portable electronic device 2A is provided with various services from the computer 10 by accessing the computer 10 using the portable electronic device 2A. In the following description of all the following embodiments, an operation of the portable electronic device 2A based on a user's operation is simply referred to as an operation of the portable electronic device 2A. For example, the portable electronic device 2A may request the computer 10 to transmit information of a charging spot at which the battery is chargeable in the vicinity of a current location.

When information of a charging spot is requested from the computer 10, the portable electronic device 2A may transmit a current location and a current residual capacity of the battery together. A target charging capacity with which the battery should be charged before a next charging opportunity may be transmitted together with the residual capacity of the battery. The portable electronic device 2A may transmit a schedule of processes which are performed before the next timing at which charging is to be performed (charging opportunity) instead of the target charging capacity. Here, the computer 10 may acquire a schedule of processes which are to be performed before the next charging opportunity from a schedule management database of users which is managed by the computer 10.

The computer 10 supports charging of the battery of the portable electronic device 2A and use of the portable electronic device 2A by a user. For example, the computer 10 receives a request for information of a charging spot from the portable electronic device 2A. The computer 10 may receive the current location, the current residual capacity of the battery, and the target charging capacity of the portable electronic device 2A along with the request for information of a charging spot. The computer 10 may access a schedule management database provided to a user using the portable electronic device 2A and acquire an action schedule of the user.

The schedule management database may be stored in the main storage unit 12 and the external storage unit 13 of the computer 10. The portable electronic device 2A can access the computer 10 via the network N2 and provide the function of the schedule management database to the user. Here, the schedule management database may be stored in the portable electronic device 2A. When the schedule management database is stored in the portable electronic device 2A, the computer 10 can get the user's approval and collect information of the schedule management database from the portable electronic device 2A. The schedule management database may be stored in another computer which can be accessed by the computer 10.

In the schedule management database, a time period in which the user does not use the portable electronic device 2A or a time period in which the user uses the portable electronic device 2A may be set in advance. The time period in which the portable electronic device 2A is not used or the time period in which the portable electronic device 2A is used may be set by the user. The portable electronic device 2A or the computer 10 may statistically process an operation history of the user and select a day, a time period, or the like in which there is a high likelihood of the portable electronic device 2A not being operated. The portable electronic device 2A or the computer 10 may present the selected day, time period, or the like to the user using the display of the portable electronic device 2A and request the user to confirm the information in advance. The computer 10 may set the day, time period, or the like in which there is a high likelihood of the portable electronic device 2A not being operated as a chargeable date and time (the next charging opportunity).

The computer 10 calculates charging times for regular charging and fast charging based on the current residual capacity and the target charging capacity of the battery of the portable electronic device 2A. The computer 10 retrieves a charging spot close to the current location of the portable electronic device 2A and a charging method available in the charging spot from a database. Then, the computer 10 notifies the portable electronic device 2A of the charging times for regular charging and fast charging, the position of the charging spot, and the available charging method.

Example of Data

Various types of data which are used for calculation by the computer 10 will be described below. The following data is stored, for example, in a database. The database according to this embodiment may be stored in the main storage unit 12 and the external storage unit 13 of the computer 10. The database may be stored in another computer which can be accessed by the computer 10.

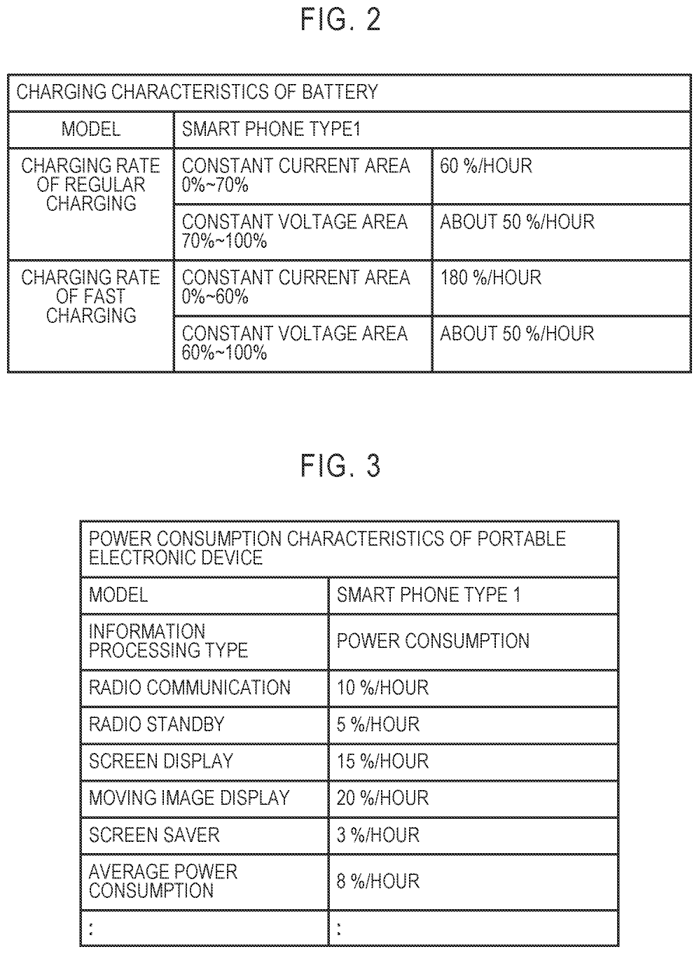

FIG. 2 is a diagram illustrating charging characteristics of the battery which are used for calculation by the computer 10. In this embodiment, the charging characteristics of the battery are prescribed, for example, for each model of the portable electronic device 2A. The computer 10 stores the charging characteristics of the battery for each model of the portable electronic device 2A in the database. FIG. 2 illustrates charging characteristics of the battery with a model SMART PHONE TYPE 1. In the example illustrated in FIG. 2, regular charging and fast charging are exemplified as the charging methods. In the example illustrated in FIG. 2, charging rates are prescribed in a constant-current area and a constant-voltage area for each of regular charging and fast charging. The computer 10 calculates the charging times to the target charging capacity for each model with reference to the database in which the charging characteristics illustrated in FIG. 2 are stored.

For example, in the regular charging, a state of charge (SOC) range of 0% to 70% is a constant-current area. In the constant-current area, charging is performed with a constant current, and the charging rate is, for example, 60%/hour. Accordingly, the battery can be charged from an SOC of 0% to an SOC of 60% through one hour of charging. In the regular charging, an SOC range of 70% to 100% is a constant-voltage area. In the constant-voltage area, charging is performed with a constant voltage. In the constant-voltage area, the charging rate decreases gradually and thus is represented as an approximate value. The charging rate of an approximate value is, for example, about 50%/hour.

In the fast charging, an SOC range of 0% to 60% is a constant-current area. In the constant-current area for fast charging, the charging rate is, for example, 180%/hour. Accordingly, for example, the battery can be charged from an SOC of 0% to an SOC of 60% through 20 minutes of charging. In this example, an SOC range of 60% to 100% is a constant-voltage area. In this example, in the constant-voltage area for fast charging, the charging rate is about 50%/hour.

FIG. 3 is a diagram illustrating power consumption characteristics of the portable electronic device 2A. The computer 10 stores power consumption characteristics for each model of the portable electronic device 2A in a database. FIG. 3 illustrates power consumption characteristics for a model SMART PHONE TYPE 1. The computer 10 may store power consumption characteristics for each maker of the portable electronic device 2A or for each product series of a maker instead of storing the power consumption characteristics for each model. Examples of the product series of a maker include an LTE-supported product, a 5G-supported product, and a 6G-supported product. The computer 10 may acquire and store average power consumption for each maker of the portable electronic device 2A.

In FIG. 3, the computer 10 stores the power consumption characteristics as a rate of change of SOC per hour for each process such as radio communication, radio standby, screen display, moving image display, or screen saver. Regardless of processes, the computer 10 may acquire and store average power consumption (average power consumption in FIG. 3) in an average operation of the portable electronic device 2A. The average operation can be acquired by statistically processing results of use of one or a plurality of users' portable electronic devices 2A. Regardless of a maker and a model, the computer 10 may store average power consumption in general portable electronic devices 2A and use the average power consumption for calculation in this embodiment.

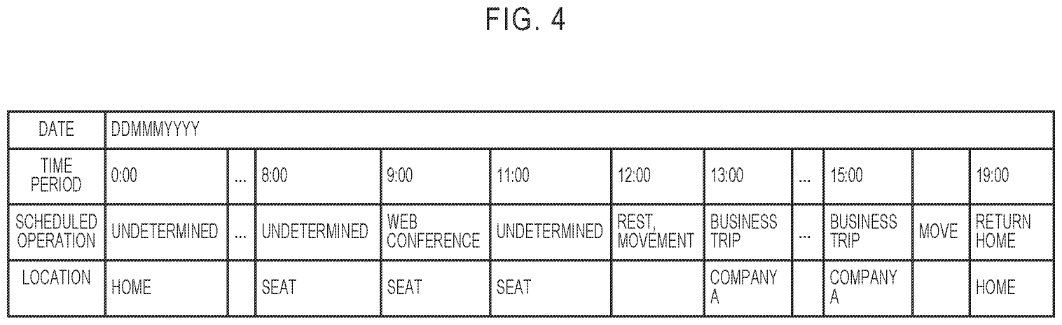

FIG. 4 illustrates an example of schedule management information of a user. In the example illustrated in FIG. 4, schedule management information for each time period of one hour on a certain date is illustrated. The schedule management information includes actions which a user is scheduled to carry out. Examples of the scheduled actions include a web conference, a business trip, and going outside. The schedule management information may include a location in which a user is located (location in FIG. 4). The location in which a user is located is, for example, a seat or a company A which is a business trip destination.

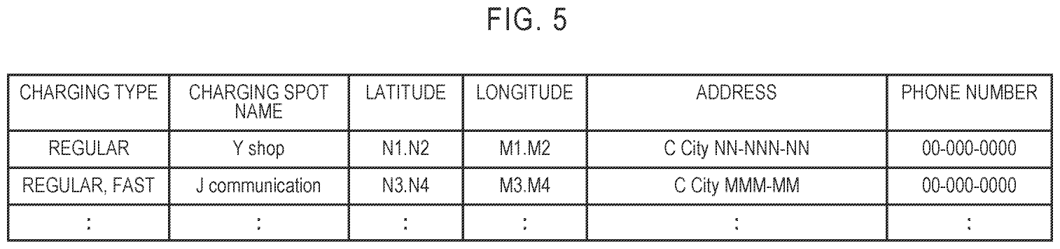

FIG. 5 illustrates a charging spot management table. The computer 10 stores a charging spot management table in a database. In the charging spot management table, each row is one record. Each record in the charging spot management table includes entries of a charging type, a charging spot name, latitude, longitude, an address, and a phone number.

The charging type is a charging method which is available in the corresponding charging spot. In FIG. 5, regular charging and fast charging are illustrated. The charging type may include more detailed information. For example, the charging type may include a charging type corresponding to a charger for each maker of the portable electronic device 2A and each product.

The charging spot name is a name indicating the corresponding charging spot and is a name which is recognizable to a user. The latitude and longitude are used to identify a position in map information. The address is an address of a spot which is recognizable to a user. The address may be information which is correlated with the latitude and longitude in a map database and which can be converted to and from the latitude and longitude.

Example of Routine

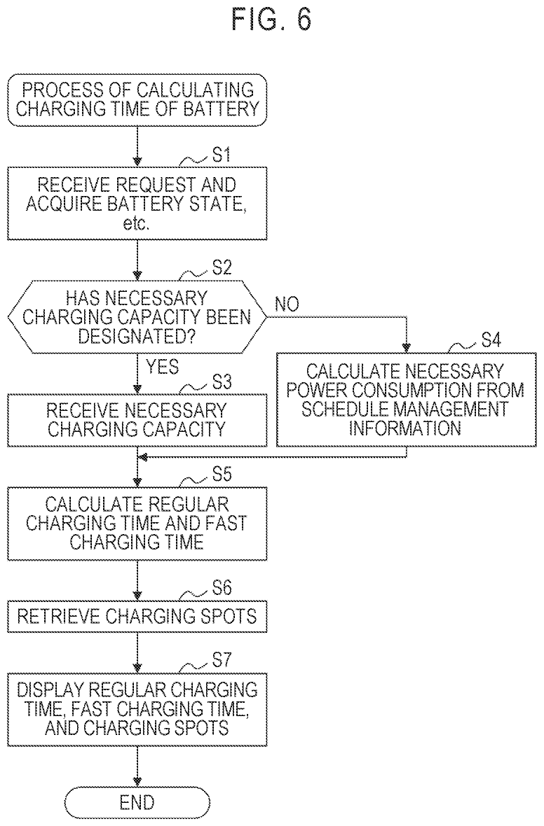

FIG. 6 is a flowchart illustrating a battery charging time calculating routine which is performed by the computer 10. The CPU 11 of the computer 10 performs the routine illustrated in FIG. 6 in accordance with a computer program which is executably loaded to the main storage unit 12. In this routine, the computer 10 receives a request for information on a charging spot from the portable electronic device 2A (S1). The computer 10 acquires a current state of charge (SOC) of the battery along with the request for information. The current SOC of the battery is also referred to as a residual capacity or a charging capacity of the battery. At this time, the computer 10 may acquire a necessary charging capacity. The necessary charging capacity is an amount of electric power necessary for operating of the portable electronic device 2A until the next charging opportunity. The necessary charging capacity may be designated as, for example, an SOC of the battery after it has been charged. The necessary charging capacity may also be referred to as a target charging capacity. When the portable electronic device 2A transmits the request for information on the charging spot to the computer 10 in the process of Step S1, it is assumed that the user has a charging opportunity to charge the battery of the portable electronic device 2A.

Then, the computer 10 determines whether the request from the portable electronic device 2A includes designation of a necessary charging capacity (S2). When the request from the portable electronic device 2A includes designation of a necessary charging capacity (YES in S2), the computer 10 receives the designated necessary charging capacity (S3). On the other hand, when the request does not include a necessary charging capacity (NO in S2), the computer 10 calculates necessary power consumption from the schedule management information of the schedule management database for the user. The computer 10 may determine that charging is not possible in a time period in which a schedule in which the user will leave a seat is included in the schedule management information of the user. The computer 10 may determine that charging is not possible during a business trip or movement for the business trip in the schedule management information for the user. On the other hand, the computer 10 may determine that charging is possible to a time period in which a location of the user is the seat or the home in the schedule management information for the user. The computer 10 may determine that charging is possible in a rest time or a free time in the schedule management information for the user. Then, the computer 10 calculates a time period (hereinafter referred to as a device operation time) from a time point at which the user is scheduled to leave the seat, a time point at which a business trip or movement for the business trip is scheduled to be started, or the like to one of a time point at which the user is scheduled to return to the seat or the home, a start time point of the free time, and a start time point of the rest time. Here, the time point at which the user is scheduled to return to the seat or the home, the start time point of the free time, or the start time point of the rest time is a next charging opportunity.

Then, the computer 10 calculates a predicted amount of power consumption from the device operation time (S4). The computer 10 can calculate the predicted amount of power consumption from the average power consumption regardless of the model of the portable electronic device 2A. When the model of the portable electronic device 2A can be acquired from the request from the portable electronic device 2A, the computer 10 may calculate the predicted amount of power consumption using the average power consumption of the model. When an information processing type in the portable electronic device 2A can be acquired from the schedule management information of the user, the computer 10 may calculate the predicted amount of power consumption based on the power consumption characteristics of the portable electronic device 2A illustrated in FIG. 3. For example, when radio standby of 5 hours (5%/hour), screen display of one hour (15%/hour), and screen saver of 4 hours (3%/hour) are performed during the business trip and movement of 5 hours, the predicted amount of power consumption is calculated as follows.

Predicted amount of power consumption=5%×5+15%×1+3%×4=52%

The computer 10 can perform the following process using the predicted amount of power consumption to the next charging opportunity as the necessary charging capacity. In the schedules (such as the business trip and the movement) of the schedule management information for the user, an information processing type which is performed by the portable electronic device 2A can be acquired, for example, by statistically processing experience values. For example, the computer 10 can combine records of a log file in which the processes of the portable electronic device 2A are recorded with the schedule management information for the user. By this combination, the computer 10 can estimate at what ratio each schedule (such as the business trip or the movement) in the schedule management information for the user was performed in the past. The necessary charging capacity acquired through the aforementioned processes can be referred to as an amount of electric power scheduled to be consumed in operation of the battery in a predetermined time by the portable electronic device 2A.

Then, the computer 10 calculates a regular charging time and a fast charging time based on the current state of charge and the necessary charging capacity of the battery (S5). That is, when both the state of charge and the necessary charging capacity of the battery are in the constant-current area, the computer 10 calculates the charging times using a charging rate in the constant-current area as follows:

Regular charging time TA=(necessary charging capacity−current state of charge of battery)/charging rate in constant-current area for regular charging; and

Fast charging time TB=(necessary charging capacity−current state of charge of battery)/charging rate in constant-current area for fast charging.

On the other hand, when the current state of charge of the battery is in the constant-current area and the necessary charging capacity is in the constant-voltage area, the computer 10 calculates the charging times in the constant-current area and the constant-voltage area. The charging time in the constant-current area is calculated as follows:

Regular charging time TA1=(SOC value between constant-current area and constant-voltage area−current state of charge of battery)/charging rate in constant-current area for regular charging; and

Fast charging time TB1=(SOC value between constant-current area and constant-voltage area−current state of charge of battery)/charging rate in constant-current area for fast charging.

The charging time in the constant-voltage area is calculated as follows:

Regular charging time TA2=(necessary charging capacity−SOC value between constant-current area and constant-voltage area)/charging rate in constant-voltage area for regular charging; and

Fast charging time TB2=(necessary charging capacity−SOC value between constant-current area and constant-voltage area)/charging rate in constant-voltage area for fast charging.

Charging time for regular charging=TA1+TA2

Charging time for fast charging=TB1+TB2

When both the state of charge and the necessary charging capacity of the battery are in the constant-voltage area, the computer 10 calculates the charging times using the charging rate in the constant-voltage area as follows:

Regular charging time TA=(necessary charging capacity−current state of charge of battery)/charging rate in constant-voltage area for regular charging; and

Fast charging time TB=(necessary charging capacity−current state of charge of battery)/charging rate in constant-voltage area for fast charging.

In this calculation, the value of the necessary charging capacity−the current state of charge of battery is referred to as a first charging capacity. The first charging capacity is a difference between the amount of electric power scheduled to be consumed in operation of the battery in a predetermined time and the current state of charge of the battery (the residual capacity of the battery). Accordingly, the process of S1 is an example of receiving designation of the amount of electric power of the battery scheduled to be consumed in the portable electronic device 2A or the first charging capacity. It can be said that the computer 10 acquires the first charging capacity from the current residual capacity of the battery and the amount of electric power of the battery scheduled to be consumed in operation of the portable electronic device 2A in a predetermined time in the process of S5. The process of S5 is an example of acquiring the charging time required for charging the battery with which the portable electronic device 2A is operated with the first charging capacity for a plurality of charging methods.

Then, the computer 10 retrieves a charging spot in the vicinity of the current location of the portable electronic device 2A from a charging spot management table (see FIG. 5) (S6). Then, the computer 10 transmits information of the necessary charging capacity, the charging time for the charging methods, and a charging spot at which the battery is chargeable using the charging methods to the portable electronic device 2A and displays the information on a display (S7). Through the process of S7, the computer 10 causes the portable electronic device 2A to display the information of the charging spot at which the battery is chargeable for a plurality of charging methods. That is, the process of S7 is an example of a process of outputting information of a first spot at which the battery is chargeable using a first charging method and a second spot at which the battery is chargeable using a second charging method in the vicinity of the portable electronic device 2A. The process of S7 is an example of notifying the portable electronic device 2A which is a predetermined device of the charging times acquired for the plurality of charging methods.

### Advantages of First Embodiment

As described above, the computer 10 according to this embodiment acquires a necessary charging capacity for operating the portable electronic device 2A until the next charging opportunity. Then, the computer 10 calculates the charging times for charging the battery with the necessary charging capacity for regular charging and fast charging from the current charging capacity of the portable electronic device 2A. Then, the computer 10 causes the display of the portable electronic device 2A to display information of the necessary charging capacity, the charging times for the charging methods, and the charging spots at which the battery is chargeable using the charging methods. Accordingly, a user of the portable electronic device 2A can recognize the charging time for charging the portable electronic device 2A with the necessary charging capacity and the charging spots at which the battery is chargeable for the plurality of charging methods. As a result, the user of the portable electronic device 2A can acquire information for determining an appropriate charging method at any time and at any place. That is, the user of the portable electronic device 2A can ascertain the charging times for the charging methods and flexibly select one charging method.

The computer 10 performs the aforementioned routine in response to a request from the portable electronic device 2A. Accordingly, the user of the portable electronic device 2A can acquire information for determining an appropriate charging method at a desired time point. The computer 10 can accurately ascertain the charging times for the plurality of charging methods based on the current state of charge and the necessary charging capacity of the battery. The computer 10 calculates an amount of electric power (necessary power consumption) when the portable electronic device 2A would be operated with the necessary charging capacity until the next charging opportunity. Accordingly, the user of the portable electronic device 2A can appropriately acquire a charging opportunity before the battery is short of energy. Since the computer 10 provides the information of the charging spots corresponding to the plurality of charging methods to the portable electronic device 2A, the user can acquire the information of the charging spots corresponding to the calculated charging times at an appropriate timing.

### Modified Examples

In this embodiment, in response to a request from the portable electronic device 2A, the computer 10 notifies the portable electronic device 2A of information of the necessary charging capacity, the charging times for the charging methods, and the charging spots at which the battery is chargeable using the charging methods and causes the display of the portable electronic device 2A to display the information. However, these processes of calculation and display may be performed by the portable electronic device 2A. The portable electronic device 2A may store the charging characteristics of the battery (FIG. 2), the power consumption characteristics (FIG. 3), the schedule management information (FIG. 4), and the like. Then, the portable electronic device 2A can perform the same routine as illustrated in FIG. 6 in response to a request from a user.

### Second Embodiment

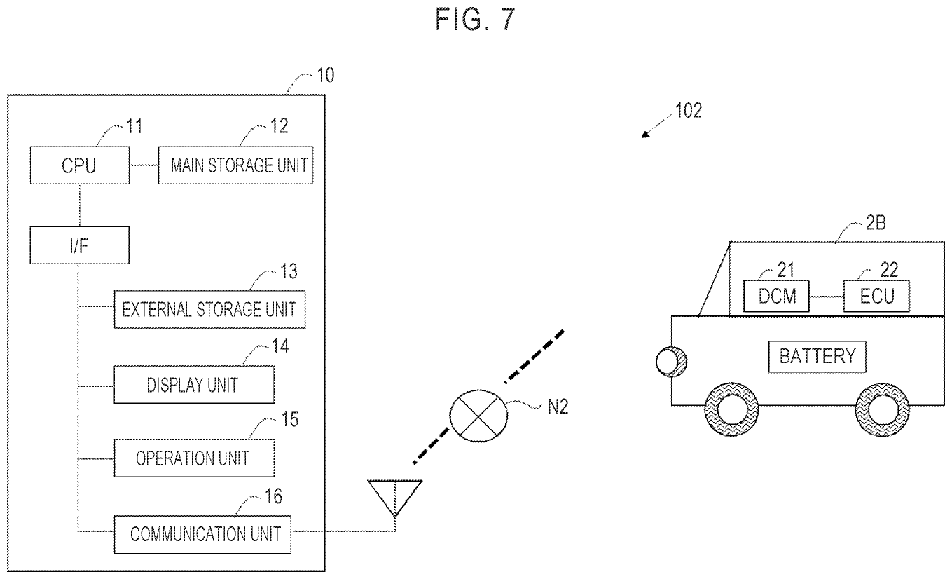

In the first embodiment, the charging times for regular charging and fast charging are calculated for the battery that operates the portable electronic device 2A. The routine according to the first embodiment can be applied to a battery which is mounted in a mobile object. FIG. 7 is a diagram illustrating a configuration of an information system 102 according to a second embodiment. The information system 102 includes a computer 10 and a mobile object 2B. The configuration of the computer 10 is the same as in the first embodiment and thus description thereof will not be repeated.

The mobile object 2B is, for example, a vehicle. The vehicle may have four wheels, three wheels, or two wheels. The vehicle may be driven by an engine or may be driven by a motor. The vehicle may be a vehicle in which an automated driving system that enables a vehicle to travel autonomously or to move automatically is mounted.

As illustrated in FIG. 1, the mobile object 2B includes a data communication module (DCM) 21 and an electrical control unit (ECU) 22. The DCM 21 communicates with another mobile object, the computer 10, and the like by accessing a network N2. The DCM 21 can perform radio communication via a mobile communication network. The network N2 is the same as in the first embodiment and thus description thereof will not be repeated.

The ECU 22 manages units in the mobile object 2B. The ECU 22 has the same elements as the CPU 11 and the main storage unit 12 of the computer 10 illustrated in FIG. 1. The ECU 22 includes, for example, a processor and a memory. The processor performs the function of the ECU 22 by executing a computer program stored in the memory. The ECU 22 provides various functions to a user of the mobile object 2B by accessing the computer 10 via the DCM 21. The ECU 22 requests the computer 10 to transmit, for example, information of a charging spot near a current location of the mobile object 2B. The ECU 22 may transmit the current location and a current residual capacity of the battery together when the computer 10 is requested to transmit the information of the charging spot similarly to the portable electronic device 2A according to the first embodiment. A target charging capacity with which the battery is wanted to be charged until a next charging opportunity may be transmitted along with the residual capacity of the battery. Here, the ECU 22 may transmit a schedule of processes which are performed until the next charging capacity instead of the target charging capacity. The computer 10 may acquire the schedule of processes which are performed until the next charging opportunity from a schedule database or the like for users which is managed by the computer 10. The ECU 22 is an example of a computer which is mounted in a vehicle.

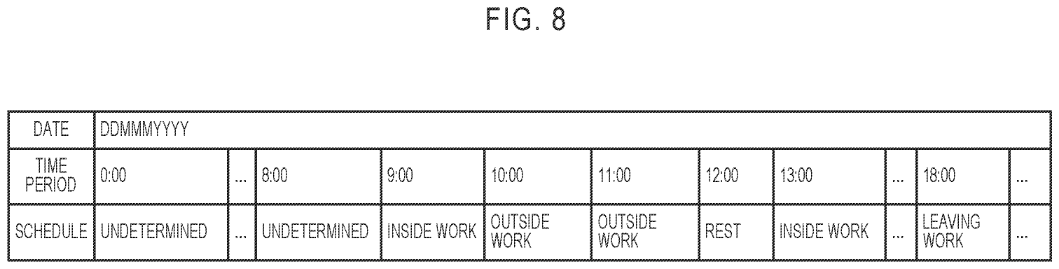

FIG. 8 illustrates an example of schedule management information for a user according to the second embodiment. In the example illustrated in FIG. 8, similarly to the example of the first embodiment illustrated in FIG. 4, schedule management information for each time period of one hour of a certain date is illustrated. The schedule management information includes actions scheduled to be carried out by the user. The scheduled actions include, for example, “inside work,” “outside work,” “rest,” and “leaving work.” For example, in case of “outside work” in the schedule management information, the computer 10 can determine that there is no charging opportunity until a next time period such as “inside work,” “rest,” or “leaving work.”

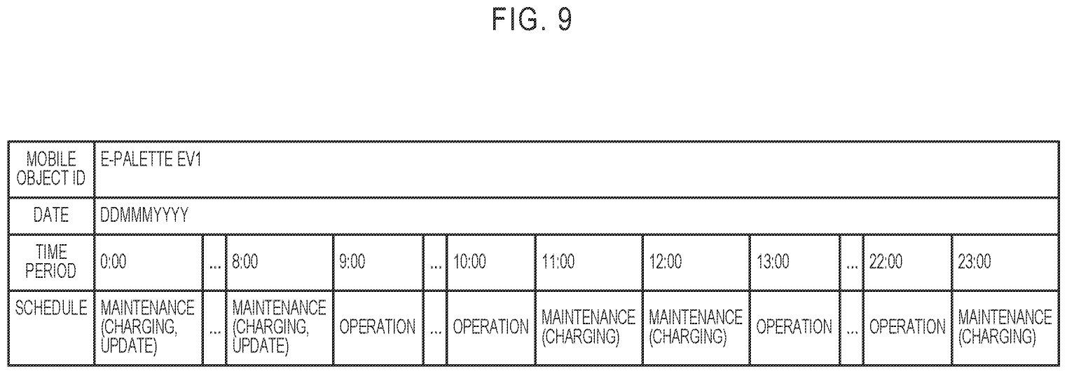

FIG. 9 is an example of operation schedule information for a mobile object 2B. The computer 10 stores the same as illustrated in FIG. 8 except that the operation schedule information for a mobile object 2B includes an entry of mobile object ID. An operation schedule is prepared for each mobile object 2B. Accordingly, the operation schedule illustrated in FIG. 9 includes a mobile object ID for identifying the mobile object 2B. In the example illustrated in FIG. 9, the operation schedule is prepared for every date and thus includes a date. In the example illustrated in FIG. 9, schedules for operation, maintenance, and the like of the mobile object 2B for each time period are prescribed in the operation schedule.

For example, maintenance of the mobile object 2B is performed between 0:00 and 9:00 on a date DDMMMYYYY. The maintenance includes charging of a battery and update of a computer program in a mobile object with a mobile ID E-PALETTE EV1. The mobile object with the mobile ID E-PALETTE EV1 operates between 9:00 and 11:00. The mobile object with the mobile ID E-PALETTE EV1 stops its operation and is subjected to maintenance such that the battery is charged between 11:00 and 13:00. The mobile object with the mobile ID E-PALETTE EV1 operates between 13:00 and 23:00, stops its operation at 23:00, and is subjected to maintenance. In the example illustrated in FIG. 9, details of the maintenance schedule and the operation schedule between 13:00 and 22:00 are not illustrated. When the operation schedule of the mobile object 2B is, for example, “operation,” the computer 10 can determine that there is no charging opportunity until a next “maintenance” time period.

In the second embodiment, the computer 10 can provide information of a charging time with a target charging capacity, that is, the necessary charging capacity, for different charging methods and charging spots using the corresponding charging methods in response to a request for information of a charging spot from the ECU 22 of the mobile object 2B. The routine of providing the information of charging spots is the same as illustrated in FIG. 6. The routine of providing the information of charging spots to the mobile object 2B will be described below with reference to FIG. 6.

Example of Routine

In this routine, the computer 10 receives a request for information of charging spots from the ECU 22 of the mobile object 2B (S1). The computer 10 acquires a current state of charge (SOC) of the battery along with the request for information.

At this time, the computer 10 may also acquire a necessary charging capacity. The necessary charging capacity is an amount of electric power necessary for operating the mobile object 2B until the next charging opportunity. The necessary charging capacity may be designated as, for example, an SOC of the battery after it has been charged. That is, the computer 10 determines whether the request from the mobile object 2B includes designation of a necessary charging capacity (S2).

When the request from the mobile object 2B includes designation of a necessary charging capacity (YES in S2), the computer 10 receives the designated necessary charging capacity (S3). On the other hand, when the request does not include a necessary charging capacity (NO in S2), the computer 10 calculates necessary power consumption from the schedule management information for the user or the operation schedule for the mobile object 2B. The computer 10 may determine that charging is not possible in a time period of “outside work” in the schedule management information for the user. When the operation schedule of the mobile object 2B indicates “operation,” the computer 10 may determine that charging is not possible. Then, the computer 10 calculates the time period of “outside work” of the user or the time period of “operation” of the mobile object 2B, that is, a device operation time.

Then, the computer 10 calculates necessary power consumption from the device operation time (S4). The computer 10 can calculate the necessary power consumption from average power consumption not depending on the model of the mobile object 2B. When the model of the mobile object 2B can be acquired from the request from the mobile object 2B, the computer 10 may calculate the necessary power consumption using the average power consumption of the corresponding model.

Then, the computer 10 calculates a regular charging time and a fast charging time based on the current state of charge and the necessary charging capacity of the battery (S5). The methods of calculating the regular charging time and the fast charging time are the same as in the first embodiment and thus description thereof will not be repeated.

Then, the computer 10 retrieves charging spots in the vicinity of the current location of the mobile object 2B from a charging spot management table (S6). The configuration of the charging spot management table is the same as illustrated in FIG. 5 except a difference between charging of the mobile object 2B and charging of the portable electronic device 2A. Then, the computer 10 transmits the necessary charging capacity, the charging times for the charging methods, and the charging spots at which the battery is chargeable using the corresponding charging methods to the mobile object 2B and causes the display of an onboard device thereof to display the transmitted information (S7).

### Advantages of Second Embodiment

As described above, the computer 10 according to this embodiment acquires a necessary charging capacity for operating the mobile object 2B until the next charging opportunity. Then, the computer 10 calculates the charging times for charging the battery with the necessary charging capacity for regular charging and fast charging from the current charging capacity of the mobile object 2B. Then, the computer 10 notifies an onboard unit mounted in the mobile object 2B of information of the necessary charging capacity, the charging times for the charging methods, and the charging spots at which the battery is chargeable using the charging methods and causes the display of the portable electronic device 2A to display the information. Accordingly, a user of the mobile object 2B can recognize the charging time for charging the mobile object 2B with the necessary charging capacity and the charging spots at which the battery is chargeable for the plurality of charging methods. As a result, the user of the mobile object 2B of the second embodiment can acquire information for determining an appropriate charging method at any time and at any place similarly to the user of the portable electronic device 2A of the first embodiment. That is, the user of the mobile object 2B can ascertain the charging times for the charging methods and flexibly select one charging method.

### Modified Examples

In this embodiment, the computer 10 calculates the necessary charging capacity and the charging times for the charging methods in response to a request from the ECU 22 of the mobile object 2B. Then, the computer 10 causes the display of the onboard unit of the mobile object 2B to display the results of calculation and the charging spots at which the battery is chargeable using the corresponding charging methods. However, these processes may be performed by the ECU 22 of the mobile object 2B. The ECU 22 of the mobile object 2B may store the charging characteristics of the battery (FIG. 2), the power consumption characteristics (that is, power consumption per hour consumed in operation), the schedule management information, and the like. The ECU 22 of the mobile object 2B can perform the same routine as illustrated in FIG. 6 in response to a request from the user.

### Other Modified Examples

The aforementioned embodiment is only an example and the present disclosure can be appropriately modified without departing from the gist thereof The processes or means described in the present disclosure can be unlimitedly combined unless technical conflictions arise.

A process which has been described to be performed by a single device may be divisionally performed by two or more devices. Alternatively, processes which have been described to be performed by different devices may be performed by a single device. In a computer system, by what hardware configuration (server configuration) each function is realized can be flexibly changed.

The present disclosure can also be realized by supplying a computer program in which the functions described above in the embodiment and the modified example are mounted to a computer and causing one or more processors of the computer to read and execute the program. This computer program may be provided to the computer using a non-transitory computer-readable storage medium which can be connected to a system bus of the computer or may be provided to the computer via a network. For example, the non-transitory computer-readable storage medium includes an arbitrary type of disk such as a magnetic disk (a floppy (registered trademark) disk or a hard disk drive (HDD)) or an optical disc (such as a CD-ROM, a DVD disc, or a Blue-ray disc) or an arbitrary type of medium suitable for storing electronic commands such as a read only memory (ROM), a random access memory (RAM), an erasable programmable ROM (EPROM), an electrically erasable programmable ROM (EEPROM), a magnetic card, a flash memory, or an optical card.

What is claimed is:

1. An information processing device comprising a control unit configured to perform:
acquiring a charging time required for charging a battery with which a predetermined device is operated with a first charging capacity for each of a plurality of charging methods; and
notifying the predetermined device of the charging times acquired for the plurality of charging methods.

2. The information processing device according to claim 1, wherein the control unit is configured to further perform notifying the predetermined device of information of a first spot in which the predetermined device is able to be charged using a first charging method and a second spot in which the predetermined device is able to be charged using a second charging method in the vicinity of the predetermined device.

3. The information processing device according to claim 1, wherein the control unit is configured to further perform acquiring the first charging capacity from a current residual capacity of the battery and an amount of electric power of the battery which is scheduled to be consumed in operating of the predetermined device in a predetermined time.

4. The information processing device according to claim 3, wherein the control unit is configured to further perform receiving designation of the amount of electric power of the battery scheduled to be consumed or the first charging capacity.

5. The information processing device according to claim 1, wherein the predetermined device is a portable terminal,
wherein the information processing device is a server that communicates with the terminal, and
wherein the control unit is configured to transmit the acquired charging time to the terminal.

6. The information processing device according to claim 1, wherein the predetermined device and the information processing device are the same portable terminal.

7. The information processing device according to claim 1, wherein the predetermined device is a vehicle that is able to travel autonomously,
wherein the information processing device is a server that communicates with the vehicle, and
wherein the control unit is configured to transmit the acquired charging time to the vehicle.

8. The information processing device according to claim 1, wherein the predetermined device is a vehicle that is able to travel autonomously, and
wherein the information processing device is a computer that is mounted in the vehicle.

9. An information processing method that is performed by a computer, the information processing method comprising:
acquiring a charging time required for charging a battery with which a predetermined device is operated with a first charging capacity for each of a plurality of charging methods; and
notifying the predetermined device of the charging times acquired for the plurality of charging methods.

10. The information processing method according to claim 9, wherein the computer further performs notifying the predetermined device of information of a first spot in which the predetermined device is able to be charged using a first charging method and a second spot in which the predetermined device is able to be charged using a second charging method in the vicinity of the predetermined device.

11. The information processing method according to claim 9, wherein the computer further performs acquiring the first charging capacity from a current residual capacity of the battery and an amount of electric power of the battery which is scheduled to be consumed in operating of the predetermined device in a predetermined time.

12. The information processing method according to claim 11, wherein the computer further performs receiving designation of the amount of electric power of the battery scheduled to be consumed or the first charging capacity.

13. A non-transitory storage medium storing a program causing a computer to perform:
acquiring a charging time required for charging a battery with which a predetermined device is operated with a first charging capacity for each of a plurality of charging methods; and
notifying the predetermined device of the charging times acquired for the plurality of charging methods.

14. The storage medium according to claim 13, wherein the computer is caused to further perform notifying the predetermined device of information of a first spot in which the predetermined device is able to be charged using a first charging method and a second spot in which the predetermined device is able to be charged using a second charging method in the vicinity of the predetermined device.

15. The storage medium according to claim 13, wherein the computer is caused to further perform acquiring the first charging capacity from a current residual capacity of the battery and an amount of electric power of the battery which is scheduled to be consumed in operating of the predetermined device in a predetermined time.

16. The storage medium according to claim 15, wherein the computer is caused to further perform receiving designation of the amount of electric power of the battery scheduled to be consumed or the first charging capacity.
